(19) United States
(12) Patent Application Publication
(10) Pub. No.: US 2016/0110705 A1
(43) Pub. Date: Apr. 21, 2016

(54) PAYMENT METHOD AND SYSTEM

(71) Applicants: William Papper, New York, NY (US); Zachery Halem, Harrison, NY (US)

(72) Inventors: William Papper, New York, NY (US); Zachery Halem, Harrison, NY (US)

(21) Appl. No.: 14/885,149

(22) Filed: Oct. 16, 2015

Related U.S. Application Data
(60) Provisional application No. 62/065,439, filed on Oct. 17, 2014.

(51) Int. Cl. G06Q 20/32

(52) U.S. Cl. CPC G06Q 20/3226; G06Q 20/3278; G06Q 20/3276; G06Q 20/3224

(57) ABSTRACT

A method and system for purchasing items from a payment device is provided. The method and system includes utilizing near field communications technology to purchase items on a per-item basis. The method and system further includes utilizing barcode technology to purchase items on a per-item basis. The method and system additionally includes utilizing beacon technology to purchase items on a per-item basis. More specifically, the method includes approaching an item desired to be purchased and opening a payment application on the payment device; transmitting purchasing data to the payment device, the purchasing data comprising item details and payment information corresponding to the item desired to be purchased; processing through the payment application the purchasing data, the processing including contacting a payment gateway to authorize a financial transaction for purchasing the item; and indicating on the payment application a successful or failed financial transaction.

### CROSS-REFERENCE TO RELATED APPLICATIONS

This application claims priority to provisional application 62/065,439, filed on Oct. 17, 2014, which is herein incorporated by reference.

### FIELD OF THE INVENTION

Embodiments of the present invention relate generally to processing financial transactions between parties, and more particularly, to utilizing a payment device and wireless technologies to purchase products on a per-item basis.

### BACKGROUND OF THE INVENTION

As modern technology grows, the capabilities of everyday electronic devices continue to expand. The day to day functions of modern smart phones, tablet computers, laptop computers, and notebook computers have made them nearly indispensable to their users. In many cases, the programs and applications that are executed on these processing devices are used to assist users in the management of their daily lives, making everyday tasks simpler, faster, and more efficient. Moreover, the miniaturization of modern processing devices has allowed users to have greater processing power in the palms of their hands. What was once the laptop computer of a few years ago is now found in a smart phone, and what was once the desktop computer is now found in a tablet computer. As a result, users are taking these mobile devices with them everywhere, and using these devices to assist in managing their lives.

One area where modern processing devices is lacking in substantial growth is payment processing. Typically, when a person walks into a store to purchase an item, the person will still have to use traditional means of currency, such as personal checks, credit/debit card, or cash to complete a purchase. Thus, there is still a need to carry around a wallet or purse having these traditional means of currency as well as a mobile device. Often, a purchaser may leave their residence and be out shopping but not have their wallet, purse, cash, or their credit card available for use either through forgetfulness or to save space in their pocket or purse. However, as modern mobile devices become more integrated into our daily lives, it is often the case that a person will have their mobile device with them.

Furthermore, most stores still use checkout lines in order to process purchases of their products. Typically, a purchaser will take whichever items they would like from a shelf and place those items in a shopping cart or basket. Then, the purchaser will wait in line at a checkout counter while a store employee processes the purchases and payment. After the employee processes their purchases and the purchaser pays for their products, the purchaser can leave with his or her purchases. Waiting in line behind another purchaser who has an abundance of items to pay for can test the patience of most.

Some stores have tried to alleviate this problem with separate checkout lines for purchasers who are only buying a small quantity of items, typically 10 items or fewer. However, purchasers still have to wait in line at a checkout counter, and even a small number of items could take a long time to process if the purchaser is slow at paying or the employee has a technical issue. For instance, even if a purchaser only has a few items, they might spend time looking for the correct amount of cash to pay from their wallet or purse, leading to backups and delays at the checkout counter. Waiting in line longer because of the purchaser ahead can be irritating, especially if buying only a single product.

Thus, there is a need for a fast and flexible payment system that avoids long checkout lines for processing purchases and payment methods.

### SUMMARY OF THE INVENTION

According to some embodiments, a method for purchasing items from a payment device utilizing near field communication (NFC) technology is provided. The method includes a purchaser approaching an item desired to be purchased and opening a payment application on the payment device, the payment application being configured for interfacing and communicating with the purchaser and a plurality of NFC tags through their NFC transceivers. The method further includes the purchaser bringing the payment device into proximity with a NFC tag of a plurality of NFC tags, the particular NFC tag being placed on or near the item desired to be purchased. The method also includes transmitting purchasing data to the payment device through NFC transceivers, the purchasing data comprising item details and payment information corresponding to the item desired to be purchased. The method further includes the payment application processing the purchasing data, including contacting a payment gateway to authorize a financial transaction for purchasing the item. The method additionally includes the payment application indicating a successful or failed financial transaction by displaying a digital receipt if successful.

According to some embodiments, a payment system utilizing NFC technology is provided. The payment system includes a payment device configured to process a financial transaction for an item desired to be purchased. The payment device includes a processor capable of reading instructions stored on a non-transitory machine readable medium for execution by the processor. The payment device also includes a payment application, which contains payment instructions for receiving purchasing data over NFC protocol and authorizing the financial transaction. The purchasing data includes item details and payment information corresponding to the item desired to be purchased. The payment device further includes a NFC transceiver capable of transmitting and/or receiving the purchasing data using NFC protocol. The payment system further includes a plurality of NFC tags, wherein each individual NFC tag is placed on or near a corresponding item desired to be purchased. Each individual NFC tag of the plurality of NFC tags includes a processor capable of reading instructions stored on a non-transitory machine-readable medium for execution by a processor, and a NFC transceiver capable of transmitting and/or receiving the purchasing data using NFC protocol. The payment system additionally includes a network capable of sending and receiving purchasing data to and from a payment gateway in order to authorize the financial transaction.

According to some embodiments, there is provided a non-transitory computer-readable medium having instructions for execution by a processor, the instructions causing the processor, when executed, to perform a method including the steps of initiating a financial transaction for an item desired to be purchased and receiving purchasing data from a near field communication (NFC) tag placed on or near the item desired to be purchased. The purchasing data is provided using NFC protocol and includes item details and payment information corresponding to the item desired to be purchased. The method also includes authorizing the financial transaction for purchasing the item by contacting a payment gateway, and indicating a successful or failed financial transaction by displaying a digital receipt if successful.

According to some embodiments, there is provided a method for purchasing items from a payment device utilizing barcode technology. The method includes approaching an item desired to be purchased and opening a payment application on the payment device. The payment application is configured for interfacing and communicating with a purchaser. The method further includes scanning a barcode corresponding to the item desired to be purchased with a camera on the payment device. The barcode is placed on or near the item desired to be purchased. The method additionally includes decoding the scanned barcode with a barcode reader program on the payment device in order to extract purchasing data stored therein. The purchasing data includes item details and payment information corresponding to the item desired to be purchased. The method further includes processing through the payment application the purchasing data, the processing including contacting a payment gateway to authorize a financial transaction for purchasing the item. The method also includes indicating on the payment application a successful or failed financial transaction by displaying a digital receipt if successful.

According to some embodiments, there is provided a payment system utilizing barcode technology. The payment system includes a payment device, a plurality of barcodes, and a network. The payment device is configured to process a financial transaction for an item desired to be purchased and includes a processor capable of reading instructions stored on a non-transitory machine-readable medium for execution by the processor, a payment application including payment instructions for receiving purchasing data extracted from scanned barcodes and authorizing the financial transaction. The purchasing data includes item details and payment information corresponding to the item desired to be purchased. The payment device further includes a camera capable of scanning a barcode corresponding to the item desired to be purchased and a barcode reader program capable of decoding the scanned barcode in order to extract purchasing data stored therein. The plurality of barcodes are each individually placed on or near a corresponding item desired to be purchased. The network is capable of sending and receiving purchasing data to and from a payment gateway in order to authorize the financial transaction.

According to some embodiments, there is provided a non-transitory computer-readable medium having instructions for execution by a processor, the instructions causing the processor, when executed, to perform a method including initiating a financial transaction for an item desired to be purchased; receiving coded data from scanning a barcode placed on or near the item desired to be purchased; extracting purchasing data from the coded data, the purchasing data including item details and payment information corresponding to the item desired to be purchased; authorizing the financial transaction for purchasing the item by contacting a payment gateway; and indicating a successful or failed financial transaction by displaying a digital receipt if successful.

According to some embodiments, there is provided a method for purchasing items from a payment device utilizing beacon technology. The method includes opening a payment application on the payment device, the payment application configured for interfacing and communication with a purchaser and a plurality of beacon through radio frequency (RF) transceivers. The method further includes walking around a beacon-enabled store such that signals from beacons nearby a purchaser triangulate to locate the purchaser and display items for purchase within reach of the purchaser's location, the display including item details and payment information. The method also includes selecting one or more items desired to be purchased on the payment application. The method further includes processing through the payment application the one or more items desired to be purchased, the processing including contacting a payment gateway to authorize a financial transaction for purchasing the item. The method additionally includes indicating on the payment application a successful or failed transaction, the payment application displaying a digital receipt if successful.

According to some embodiments, there is provided a payment system utilizing beacon technology including a payment device, a plurality of beacons, and a network. The payment device is configured to process a financial transaction for an item desired to be purchased and includes a processor capable of reading instructions stored on a non-transitory machine-readable medium for execution by the processor. The payment device further includes a payment application including payment instructions for receiving purchasing data over radio frequency (RF) protocol and authorizing the financial transaction, the purchasing data including item details and payment information corresponding to the item desired to be purchased. The payment device also includes a RF transceiver capable of transmitting and/or receiving purchasing data using RF protocol. Each individual beacon of the plurality of beacons is placed throughout a store to triangulate location data corresponding to items desired to be purchased. Each individual beacon of the plurality of beacons includes a processor capable of reading instructions stored on a non-transitory machine-readable medium for execution by a processor, and a RF transceiver capable of transmitting and/or receiving the purchasing data using RF protocol. The network is capable of sending and receiving purchasing data to and from a payment gateway in order to authorize the financial transaction.

According to some embodiments, there is provided a non-transitory computer-readable medium having instructions for execution by a processor, the instructions causing the processor, when executed, to perform a method including initiating a financial transaction for an item desired to be purchased; receiving purchasing data from a plurality of beacons placed throughout a store to triangulate location data corresponding to items desired to be purchased, the purchasing data including item details and payment information; authorizing the financial transaction for purchasing the item by contacting a payment gateway; and indicating a successful or failed financial transaction by displaying a digital receipt if successful.

Various other features and advantages will be made apparent from the following detailed description and the drawings.

### BRIEF DESCRIPTION OF THE DRAWINGS

In order for the advantages of the invention to be readily understood, a more particular description of the invention briefly described above will be rendered by reference to specific embodiments that are illustrated in the appended drawings. It is noted that the drawings of the invention are not to scale. The drawings are mere schematics representations, not intended to portray specific parameters of the invention. Understanding that these drawings depict only typical embodiments of the invention and are not, therefore, to be considered to be limiting its scope, the invention will be described and explained with additional specificity and detail through the use of the accompanying drawings, in which:

FIG. 1 is a block diagram of a payment system utilizing near field communications technology according to an embodiment of the present invention;

FIG. 2 is a diagram of a payment device utilizing near field communications technology held by a purchaser according to an embodiment of the present invention;

FIG. 3 is a flowchart illustrating a payment method utilizing near field communications technology according to an embodiment of the present invention;

FIG. 4 is a block diagram of a payment system utilizing barcode technology according to an embodiment of the present invention;

FIG. 5 is a diagram of a payment device utilizing barcode technology held by a purchaser according to an embodiment of the present invention;

FIG. 6 is a flowchart illustrating payment method utilizing barcode technology according to an embodiment of the present invention;

FIG. 7 is a block diagram of a payment system utilizing beacon technology according to an embodiment of the present invention;

FIG. 8 is a diagram of a payment device utilizing beacon technology according to an embodiment of the present invention;

FIG. 9 is a flowchart diagram of a payment method utilizing beacon technology according to an embodiment of the present invention.

In the drawings, elements having the same designation have the same or similar functions.

### DETAILED DESCRIPTION OF THE INVENTION

For the purposes of promoting an understanding of the principles of the invention, reference will now be made to the exemplary embodiments illustrated in the drawings, and specific language will be used to describe the same. It will nevertheless be understood that no limitation of the scope of the invention is thereby intended. Any alterations and further modifications of the inventive features illustrated herein, and any additional applications of the principles of the invention as illustrated herein, which would occur to one skilled in the relevant art and having possession of this disclosure, are to be considered within the scope of the invention.

Reference throughout this specification to an “embodiment,” an “example” or similar language means that a particular feature, structure, characteristic, or combinations thereof described in connection with the embodiment is included in at least one embodiment of the present invention. Thus, appearances of the phrases an “embodiment,” an “example,” and similar language throughout this specification may, but do not necessarily, all refer to the same embodiment, to different embodiments, or to one or more of the figures. Additionally, reference to the wording “embodiment,” “example” or the like, for two or more features, elements, etc. does not mean that the features are necessarily related, dissimilar, the same, etc.

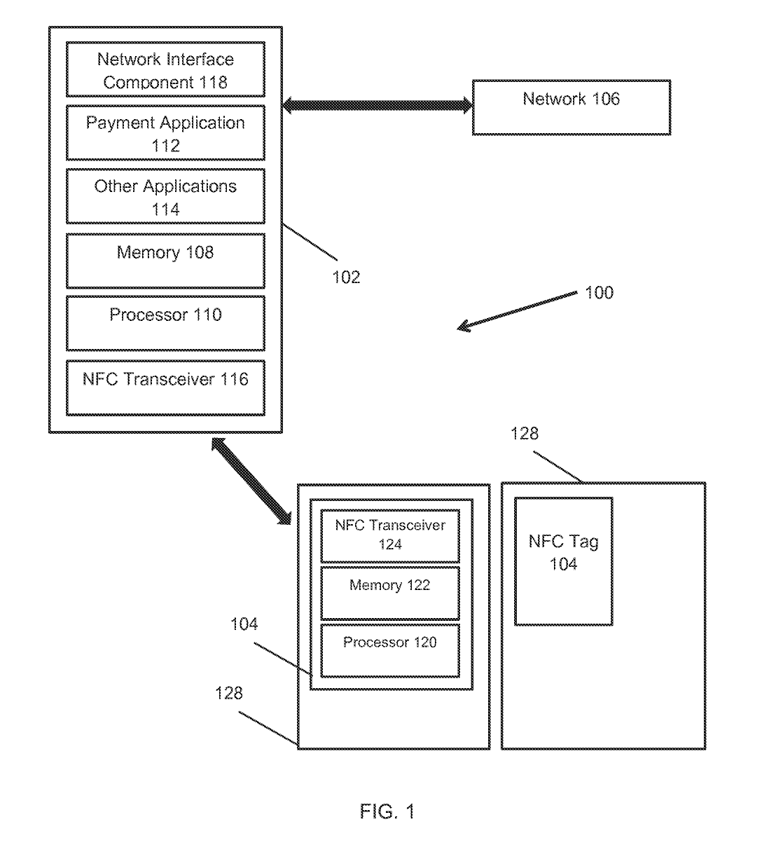

FIG. 1 illustrates a block diagram of a payment system utilizing near field communications technology according to an embodiment of the present invention. Near field communication (NFC) refers to short range wireless radio communication between two devices, typically occurring over short distances such as a few centimeters.

As shown in FIG. 1, payment system 100 includes a payment device 102, a plurality of NFC tags 104, and a network 106. According to some embodiments, network 106 may be implemented as a single network or a combination of multiple networks. Network 106 may include a wireless telecommunications networks adapted for communication with one or more other communication networks, such as the internet. Network 106 may also include the internet, one or more intranets, landline networks, wireless networks, and other communication networks.

According to some embodiments, payment device 102 may include any appropriate combination of hardware or software having a processor and capable of reading instructions stored on a non-transitory machine-readable medium for execution by the processor. Some common forms of machine-readable media include but are not limited to floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a processor or computer is adapted to read. Payment device 102 may also be configured for wired or wireless communication over network 106. Payment device 102 may be a mobile device, such as a mobile phone, a smart phone, or a tablet computer. Payment device 102 may also be a processing device such as a personal computer, a personal digital assistant (PDA), or a notebook computer. Payment device 102 further includes memory 108 or other machine-readable medium which includes instructions for execution by a processor 110 for causing payment device 102 to perform specific functions, such as but not limited to a payment application 112 and other applications 114.

According to some embodiments, payment application 112 can be utilized by a purchaser to create a digital shopping cart, purchase products, process payments, or other financial transactions utilizing the plurality of NFC tags 104 and network 106. NFC tag 104 can receive a NFC transmission sent from NFC transceiver 116. Payment device 102 may also be linked to a payment account stored in an account database on a payment provider server (not shown) for direct or automatic payment or exchange of funds between the purchase and merchant. Payment application 112 includes instructions for execution by a processor 110, such as a software program or application, that provides a graphical user interface (GUI) for interfacing and communicating with the purchaser and the plurality of NFC tags 104 through network 106 or NFC transceiver 116. In some embodiments, payment application 110 may allow a purchaser to enter recipient payment information, purchaser account information, or log in information to access the purchaser's account information or other related information that may permit a purchaser to make a payment to a merchant. Payment application 110 also may include a payment gateway to authorize or reject payment transactions through a third party service provider (not shown) utilizing network 106.

Payment device 102 further includes a network interface component 118 configured for communication with network 106. According to some embodiments, network interface component 118 includes a wireless communication component, such as a wireless broadband component, a wireless satellite component, or other types of wireless communication components including radio frequency (RF), microwave frequency (MWF), or infrared (IR) components configured for communication with network 106. Network interface component 118 may also be configured to interface with a digital subscriber line (DSL) modem, a public switched telephone network (PSTN) modem, an Ethernet device, or various other types of wired or wireless network communication devices adapted for communication with network 106.

According to some embodiments, the plurality of NFC tags 104 may include any appropriate combination of hardware or software having a processor 120 and capable of reading instructions stored in memory 122 or other machine-readable medium for execution by the processor 120. The NFC tags 104 include a NFC transceiver 124 capable of transmitting and/or receiving communications transmitted using an NFC protocol. The NFC tags 104 typically will store data related to products desired to be purchased 128 such as but not limited to product details and payment information. According to some embodiments, the NFC tags 104 are fixed to individual products 128 in a store. In alternative embodiments, the NFC tags 104 may be fixed to store shelves or placed nearby the individual products. This enables a purchaser to quickly pay for particular products that the purchaser would like to buy, without having to wait at a checkout line. The purchaser holds their payment device 102 close to the products with the NFC tags 104 they wish to purchase. The payment application 112 will process and authorize the transaction, displaying a receipt screen if successful. The purchaser may then leave the store with the purchased product, or continue to shop for other products and repeating the payment process utilizing the payment device 102 for the other products. The purchaser thus saves time by avoiding checkout lines to purchase products.

The plurality of NFC tags 104 may also include a network interface component (not shown) configured for communication with network 106. According to some embodiments, network interface component includes a wireless communication component, such as a wireless broadband component, a wireless satellite component, or other types of wireless communication components including radio frequency (RF), microwave frequency (MWF), or infrared (IR) components configured for communication with network 106. Network interface component may also be configured to interface with a digital subscriber line (DSL) modem, a public switched telephone network (PSTN) modem, an Ethernet device, or various other types of wired or wireless network communication devices adapted for communication with network 106. The network interface component may be utilized to store data on purchases and price information from the NFC tags 104 to a third party server. A merchant may wish to use this data to determine which products or how much of a product is being purchased during a specified period. The merchant can use this data to efficiently stock their store with more products purchasers desire and less products purchasers seldom buy.

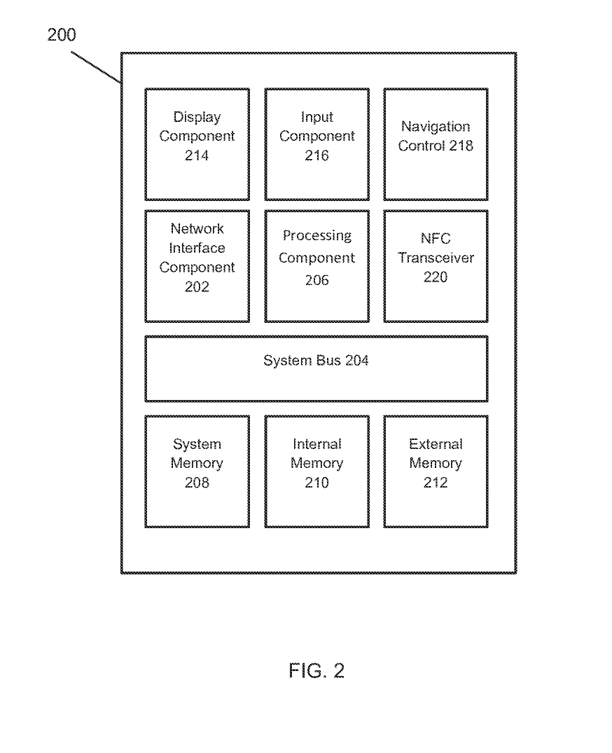

FIG. 2 is a diagram of a payment device 200 held by a purchaser according to an embodiment of the present invention. Payment device 200 may correspond to payment device 102 in FIG. 1. Payment device 200 may be a mobile device, such as a smart phone, mobile phone, netbook, notebook computer, or tablet computer. Device 200 include a network interface component 202 configured for communication with a network such as network 106 in FIG. 1. According to some embodiments, network interface component 202 includes a wireless communication component, such as a wireless broadband component, a wireless satellite component, or various other types of wireless communication components including radio frequency (RF), microwave frequency (MWF), or infrared (IR) components configured for communication with network 106. In other embodiments, network interface component may be configured to interface with a digital subscriber line (DSL) modem, a public switched telephone network (PSTN) modem, an Ethernet device, or various other types of wired or wireless network communication devices adapted for communication with network 106.

According to some embodiments, payment device 200 includes a system bus 204 for interconnecting various components within payment device 200 and communication information between the various components. Various components may include but are not limited to a processing component 206, a system memory component 208, an internal memory component 210, and a static memory component 212. Processing component 206 may encompass but is not limited to a processor, microcontroller, or a digital signal processor (DSP). System memory component 208 may correspond to random access memory (RAM), internal memory component 210 may correspond to read-only memory (ROM), and static memory 212 may correspond to optical, magnetic, or solid-state memories.

According to some embodiments, payment device 200 includes a display component 214 for displaying information to a purchaser using payment device 200. Display component 214 may be a liquid crystal display (LCD) screen, an organic light emitting diode (OLED) screen, an active matrix OLED (AMOLED), an LED screen, a plasma display, or a cathode ray tube (CRT) display. Payment device 200 further includes an input component 216, which enables a purchaser using payment device 200 to input information into payment device 200. Such information could include but is not limited to payment information, account information, verification information, or identification information. In some embodiments, input component 216 may include a keyboard or key pad. Payment device 200 may also include a navigation control component 218, configured to enable a purchaser using the device 200 to navigate along display component 214. In some embodiments, navigation control component 218 may be a mouse, a trackball, or other such device. In other embodiments, payment device 200 includes a touchscreen such that display component 214, input component 216, and navigation control 218 may be a single integrated component.

According to some embodiments, payment device 200 includes a NFC transceiver 220 for transmitting and receiving information over a NFC protocol. NFC is a set of short range wireless technologies, typically transmitting over short distances such as a few centimeters. In some embodiments, NFC operates at a frequency of about 13.56 MHz and at rates varying from about 106 kbit/s to about 848 kbit/s. NFC transceiver 220 may be utilized by payment device 200 to transmit information over a short distance to nearby products or shelves with NFC tags 104 using NFC protocol. Such information may include but is not limited to payment information, identification information, or account information.

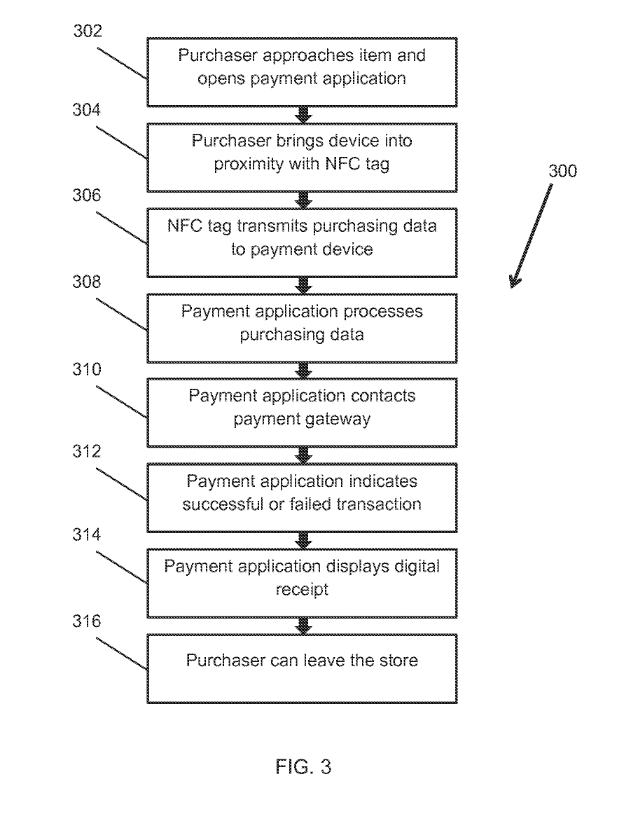

FIG. 3 is a flowchart illustrating a payment method 300 utilizing near field communications technology according to an embodiment of the present invention. The method 300 illustrated in FIG. 3 will be described in association with FIG. 1. According to some embodiments, the method 300 shown in FIG. 3 may allow a purchaser with a payment device, such as payment device 102 having NFC transceiver 116, payment application 112, and network connectivity through network interface component 118 to purchase products from a merchant without having to wait in line at a checkout counter. It is understood that steps in method 300 may be repeated, rearranged, or removed without limiting the object and scope of the invention.

As the start of the payment method 300 in FIG. 3, the purchaser is inside a store and has found an item they would like to purchase. Optionally, a purchaser may bring the payment device into proximity with a store-identifying NFC tag in order to transmit to the payment application which store the purchaser is inside. Alternatively, the store could be recognized through location data such as but not limited to utilizing a global positioning system (GPS). At step 302, the purchaser approaches the item desired to be purchased and opens the payment application 112 on their payment device 102. At step 304, the purchaser brings the payment device 102 into proximity with the NFC tag 104 corresponding to the item they would like to purchase. The NFC tag 104 may be directly on the item to be purchased or may be nearby on a shelf holding the item. At step 306, NFC tag 104 transmits purchasing data to the payment device 102 utilizing NFC protocol. The NFC tag 104 transmits data and the payment device 102 receives data through their respective NFC transceivers 124 and 116. At step 308, payment application 112 processes the purchasing data corresponding to the item desired to be purchased. More than one item desired to be purchased may be processed before the purchaser utilizes the payment application 112 to purchase their items. For instance, a purchaser may repeat steps 302 through 308 until the purchaser has determined he or she has all the items desired to be purchased. The payment application 112 may collect this data and provide the purchaser with a list of items, corresponding prices, and a total price of all items displayed on the payment device 102. The purchaser may then have the ability to remove items from the list displayed on the payment device 102 should they ultimately decide not to purchase an item. Removing an item further includes bringing the payment device 102 into proximity with the NFC tag 104 in order to transmit to the NFC tag 104 that the item is no longer being purchased. This ensures that purchasers cannot avoid paying by removing items from the payment list but physically keeping them after they have been tagged.

At step 310, the purchaser has completed shopping, so the payment application 112 contacts the payment gateway to authorize the payment transaction. The payment transaction is authorized through a third party payment processor based on previously input purchaser information, such as but not limited to credit or debit card information. The payment transaction also incorporates any discounts or price reductions, through the use of coupons, rewards cards, rebates, or other price reduction means. Additional security features may be implemented as well, such as purchaser authentication, in order to prevent fraudulent payment transactions. The authentication request may result in a notification on the payment device 102 asking for authorization. The request for authentication may also be a short messaging service (SMS) message or an e-mail requesting a reply to authorize the transaction. The purchaser then replies to the notification, message, or email in order to continue the payment process. At step 312, based on receipt and processing from the third party payment gateway, a success or failure message is displayed on the payment device 102 in order to inform the purchaser that their payment was successful or not. At step 314, if the payment was processed successfully, a receipt is displayed on the patent device 102; otherwise, an error message is displayed to alert the purchaser that their payment was not successful. If successful, at step 316, the purchaser is free to leave the store with their purchased item, optionally displaying the receipt to a store clerk prior to leaving. After a successful purchase, the payment device may optionally send a request to deactivate pre-existing antitheft mechanisms (such as but not limited to RFID tags) that merchants may have placed on higher value items. The purchaser may also continue to shop by repeating the previous steps throughout this method.

In an alternative embodiment, payment authorization at step 310 is commenced at a later time from payment processing such that a purchaser may purchase items from multiple stores, the payment application ultimately compiling and authenticating all the purchases at a later time when the purchaser has completed shopping entirely.

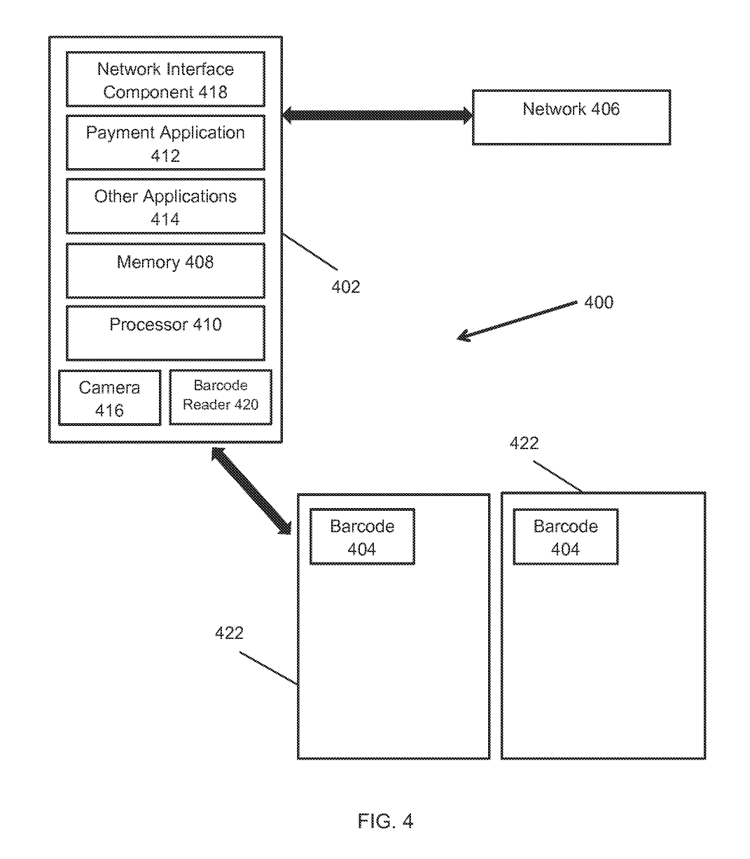

FIG. 4 illustrates a block diagram of a payment system utilizing barcode technology according to an embodiment of the present invention. Barcode may refer to any printed label that can be scanned and processed by a device.

As shown in FIG. 4, payment system 400 includes a payment device 402, a plurality of barcodes 404, and a network 406. According to some embodiments, network 406 may be implemented as a single network or a combination of multiple networks. Network 406 may include a wireless telecommunications networks adapted for communication with one or more other communication networks, such as the internet. Network 406 may also include the internet, one or more intranets, landline networks, wireless networks, and other communication networks.

According to some embodiments, payment device 402 may include any appropriate combination of hardware or software having a processor and capable of reading instructions stored on a non-transitory machine-readable medium for execution by the processor. Some common forms of machine-readable media include but are not limited to floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a processor or computer is adapted to read. Payment device 402 may also be configured for wired or wireless communication over network 406. Payment device 402 may be a mobile device, such as a mobile phone, a smart phone, or a tablet computer. Payment device 402 may also be a processing device such as a personal computer, a personal digital assistant (PDA), or a notebook computer. Payment device 402 further includes memory 408 or other machine-readable medium which includes instructions for execution by a processor 410 for causing payment device 402 to perform specific functions, such as but not limited to a payment application 412 and other applications 414.

According to some embodiments, payment application 412 can be utilized by a purchaser to create a digital shopping cart, purchase products, process payments, or other financial transactions utilizing the plurality of barcodes 404 and network 406. Payment device 402 may also be linked to a payment account stored in an account database on a payment provider server (not shown) for direct or automatic payment or exchange of funds between the purchase and merchant. Payment application 412 includes instructions for execution by a processor 410, such as a software program or application, that provides a graphical user interface (GUI) for interfacing and communicating with the purchaser and the plurality of NFC tags 404 through network 406 or NFC transceiver 416. In some embodiments, payment application 410 may allow a purchaser to enter recipient payment information, purchaser account information, or log in information to access the purchaser's account information or other related information that may permit a purchaser to make a payment to a merchant. Payment application 410 also may include a payment gateway to authorize or reject payment transactions through a third party service provider (not shown) utilizing network 406.

Payment device additionally includes a camera 416 for scanning the plurality of barcodes 404 by taking individual pictures of them. While an exemplary embodiment utilizes a camera, other scanning capable devices may be used as well. A barcode reader program 420 can then decode the scanned barcode 404 and extract the data stored therein. The decoded data is used by the payment application 412 for processing purchases.

Payment device 402 further includes a network interface component 418 configured for communication with network 406. According to some embodiments, network interface component 418 includes a wireless communication component, such as a wireless broadband component, a wireless satellite component, or other types of wireless communication components including radio frequency (RF), microwave frequency (MWF), or infrared (IR) components configured for communication with network 406. Network interface component 418 may also be configured to interface with a digital subscriber line (DSL) modem, a public switched telephone network (PSTN) modem, an Ethernet device, or various other types of wired or wireless network communication devices adapted for communication with network 406.

According to some embodiments, the plurality of barcodes 404 may include one-dimensional (1D) barcodes, two-dimensional (2D) barcodes, or three-dimensional (3D) barcodes. A 1D barcode is a horizontal linear code representing a number or simple characters through a combination and arrangement of bars (typically black bars) and spaces (typically white bars). The 1D barcode includes bars arranged only in a horizontal direction (X-axis direction) and does not contain any information in a vertical direction (Y-axis direction), thereby limiting information storage capacity. A 2D barcode is a dot-shaped or matrix code that includes planar information arranged in both horizontal and vertical directions. The 2D barcode overcomes the limited information capacity problem of 1D barcodes. The 2D barcode can encode about 100 times as much information as the 1D barcode in the same area in the form of a 2D symbol within a small square. Therefore, the 2D barcode can contain various types of information including not only text such as letters and numbers but also graphics, photos, voice, fingerprints, and signatures. Some examples of 2D barcodes include but are not limited to PDF417, DataMatrix, MaxCod, and QR code. A 3D barcode is similar to the 2D barcode but further includes information in a third height direction (Z-axis direction). This gives 3D barcodes the ability to store even more data than 2D barcodes. The barcodes 404 typically will include data related to products desired to be purchased 422 such as but not limited to product details and payment information. The barcodes 404 may be fixed to individual products 422 in a store, or alternatively placed on store shelves or nearby the individual products 422. This enables a purchaser to quickly pay for particular products that the purchaser would like to buy, without having to wait at a checkout line. The purchaser takes a picture using the camera 416 from their payment device 402 of the barcode 404 relating to the product 422 they wish to purchase. The barcode reader 420 in the payment device 402 will decode the data for use by the payment application 412. The payment application 412 will then process and authorize the transaction, displaying a receipt screen if successful. The purchaser may then leave the store with the purchased product, or continue to shop for other products and repeating the payment process utilizing the payment device 402 for the other products. The purchaser thus saves time by avoiding checkout lines to purchase products.

The plurality of barcodes 404 may additionally be used by a merchant to keep track of product information. The merchant may wish to determine which products or how much of a product is being purchased during a specified period. The merchant can use this data to efficiently stock their store with more products purchasers desire and less products purchasers seldom buy.

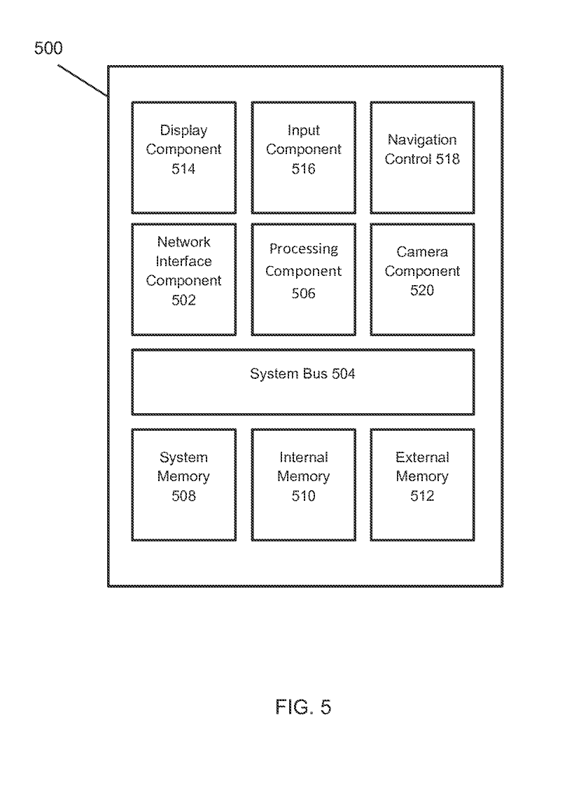

FIG. 5 is a diagram of a payment device 500 held by a purchaser according to an embodiment of the present invention. Payment device 500 may correspond to payment device 402 in FIG. 4. Payment device 500 may be a mobile device, such as a smart phone, mobile phone, netbook, notebook computer, or tablet computer. Device 500 include a network interface component 502 configured for communication with a network such as network 406 in FIG. 4. According to some embodiments, network interface component 502 includes a wireless communication component, such as a wireless broadband component, a wireless satellite component, or various other types of wireless communication components including radio frequency (RF), microwave frequency (MWF), or infrared (IR) components configured for communication with network 406. In other embodiments, network interface component may be configured to interface with a digital subscriber line (DSL) modem, a public switched telephone network (PSTN) modem, an Ethernet device, or various other types of wired or wireless network communication devices adapted for communication with network 406.

According to some embodiments, payment device 500 includes a system bus 504 for interconnecting various components within payment device 500 and communication information between the various components. Various components may include but are not limited to a processing component 506, a system memory component 508, an internal memory component 510, and a static memory component 512. Processing component 506 may encompass but is not limited to a processor, microcontroller, or a digital signal processor (DSP). System memory component 508 may correspond to random access memory (RAM), internal memory component 510 may correspond to read-only memory (ROM), and static memory 512 may correspond to optical, magnetic, or solid-state memories.

According to some embodiments, payment device 500 includes a display component 514 for displaying information to a purchaser using payment device 500. Display component 514 may be a liquid crystal display (LCD) screen, an organic light emitting diode (OLED) screen, an active matrix OLED (AMOLED), an LED screen, a plasma display, or a cathode ray tube (CRT) display. Payment device 500 further includes an input component 516, which enables a purchaser using payment device 500 to input information into payment device 500. Such information could include but is not limited to payment information, account information, verification information, or identification information. In some embodiments, input component 516 may include a keyboard or key pad. Payment device 500 may also include a navigation control component 518, configured to enable a purchaser using the device 500 to navigate along display component 514. In some embodiments, navigation control component 518 may be a mouse, a trackball, or other such device. In other embodiments, payment device 500 includes a touchscreen such that display component 514, input component 516, and navigation control 518 may be a single integrated component.

According to some embodiments, payment device 500 includes a camera 520 and barcode reader program 522. Barcode refers to any printed label that can be scanned and processed by a device. Camera 520 is typically but not limited to a mobile phone camera or smartphone camera; however other camera technologies may be used as well without departing from the scope and spirit of the present invention. Payment device 500 may utilize display component 514, input component 516, and navigation control 518 as a touchscreen to direct camera 520 to zoom in or focus on a particular barcode. Camera 520 may use complementary metal oxide semiconductor (CMOS) image sensors, back side illuminated CMOS, or a charge coupled device (CCD). Camera 520 may be utilized by payment device 500 to scan barcodes 404 by taking pictures and then decoding the barcodes 404 with barcode reader program 420 to extract the data for payment application 412 to process. Such data may include but is not limited to payment information, product identification information, or account information.

According to some embodiments, payment device 500 includes a barcode scanner (not shown) or other scanning capable device for scanning and processing barcodes. Examples include but are not limited to pen-type readers, laser scanners, CCD readers (or LED scanners), and omni-directional barcode scanners.

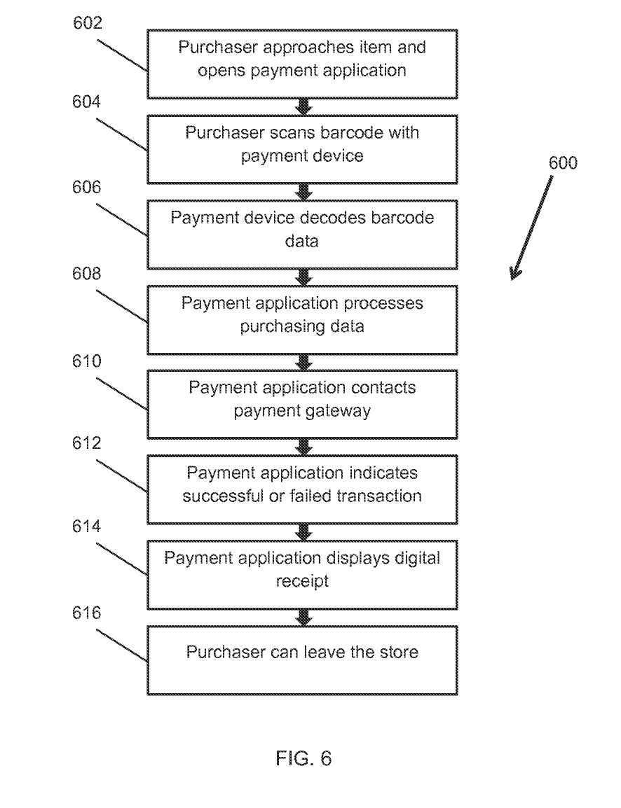

FIG. 6 is a flowchart illustrating a payment method 600 utilizing barcode technology according to an embodiment of the present invention. The method 600 illustrated in FIG. 6 will be described in association with FIG. 4. According to some embodiments, the method 600 shown in FIG. 6 may allow a purchaser with a payment device, such as payment device 402 having camera 416, barcode reader 420, payment application 412, and network connectivity through network interface component 418 to purchase products from a merchant without having to wait in line at a checkout counter. It is understood that steps in method 600 may be repeated, rearranged, or removed without limiting the object and scope of the invention.

As the start of the payment method 600 in FIG. 6, the purchaser is inside a store and has found an item they would like to purchase. Optionally, a purchaser may scan a store-identifying barcode in order to transmit to the payment application which store the purchaser is inside. Alternatively, the store could be recognized through location data such as but not limited to utilizing a GPS. At step 602, the purchaser approaches the item desired to be purchased and opens the payment application 412 on their payment device 402. At step 604, the purchaser scans a barcode 404 corresponding to the item desired to be purchased by taking a picture with the camera 416 on their payment device 402. The barcode 404 may be directly on the item to be purchased or may be nearby on a shelf holding the item. At step 606, the payment device, using the barcode reader program 420, detects the presence of the barcode 404 and decodes the scanned barcode 404, extracting the purchasing data stored therein. At step 608, payment application 412 processes the purchasing data corresponding to the item desired to be purchased. The purchasing data and merchant information are sent to and saved on a payment server through network 406. More than one item desired to be purchased may be processed before the purchaser utilizes the payment application 412 to purchase their items. For instance, a purchaser may repeat steps 602 through 608 until the purchaser has determined he or she has all the items desired to be purchased. The payment application 412 may collect this data and provide the purchaser with a list of items, corresponding prices, and a total price of all items displayed on the payment device 402. The purchaser may then have the ability to remove items from the list displayed on the payment device 402 should they ultimately decide not to purchase an item. Removing an item further includes rescanning the barcode 404 in order to transmit that the item is no longer being purchased. This ensures that purchasers cannot avoid paying by removing items from the payment list but physically keeping them after they have been tagged.

At step 610, the purchaser has completed shopping, so the payment application 412 contacts the payment gateway to authorize the payment transaction. The payment transaction is authorized through a third party payment processor based on previously input purchaser information, such as but not limited to credit or debit card information. The payment transaction also incorporates any discounts or price reductions, through the use of coupons, rewards cards, rebates, or other price reduction means. Additional security features may be implemented as well, such as purchaser authentication, in order to prevent fraudulent payment transactions. The authentication request may result in a notification on the payment device 402 asking for authorization. The request for authorization may also be a short messaging service (SMS) message or an e-mail requesting a reply to authorize the transaction. The purchaser then replies to the notification, message, or email in order to continue the payment process. At step 612, based on receipt and processing from the third party payment gateway, a success or failure message is displayed on the payment device 402 in order to inform the purchaser that their payment was successful or not. At step 614, if the payment was processed successfully, a receipt is displayed on the patent device 402; otherwise, an error message is displayed to alert the purchaser that their payment was not successful. If successful, at step 616, the purchaser is free to leave the store with their purchased item, optionally displaying the receipt to a store clerk prior to leaving. After a successful purchase, the payment device may optionally send a request to deactivate pre-existing antitheft mechanisms (such as but not limited to RFID tags) that merchants may have placed on higher value items. The purchaser may alternatively continue to shop by repeating the previous steps throughout this method.

In an alternative embodiment, payment authorization at step 610 is commenced at a later time from payment processing such that a purchaser may purchase items from multiple stores, the payment application ultimately compiling and authenticating all the purchases at a later time when the purchaser has completed shopping entirely.

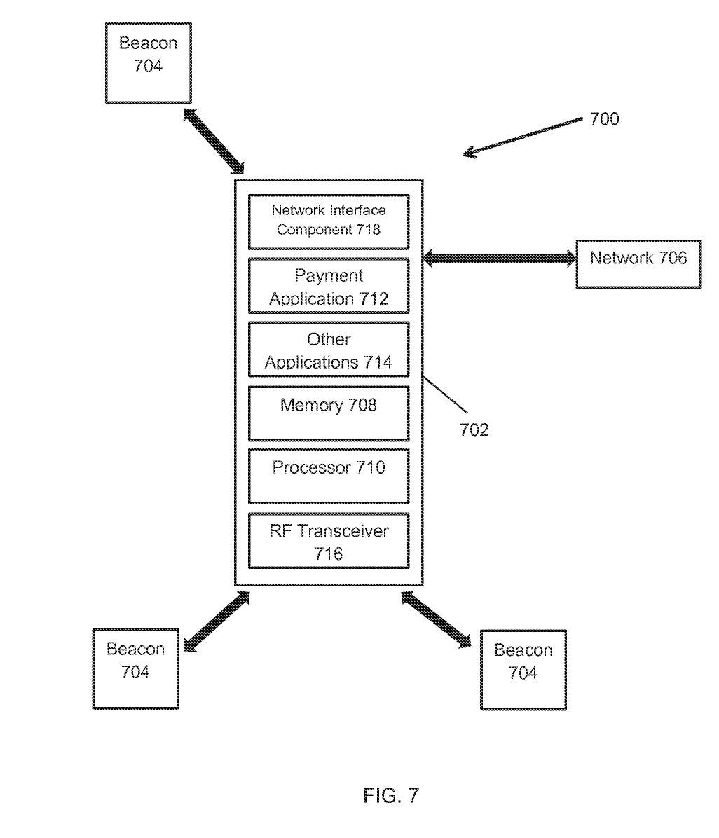

FIG. 7 illustrates a block diagram of a payment system utilizing beacon technology according to an embodiment of the present invention. Beacon technology may refer to exchanging data over short distances wirelessly from fixed and mobile devices utilizing ultra-high frequency (UHF) radio waves. A preferred but not limiting example of beacon technology is Bluetooth Low Energy (BLE).

As shown in FIG. 7, payment system 700 includes a payment device 702, a plurality of beacons 704, and a network 706. According to some embodiments, network 706 may be implemented as a single network or a combination of multiple networks. Network 706 may include a wireless telecommunications networks adapted for communication with one or more other communication networks, such as the internet. Network 706 may also include the internet, one or more intranets, landline networks, wireless networks, and other communication networks.

According to some embodiments, payment device 702 may include any appropriate combination of hardware or software having a processor and capable of reading instructions stored on a non-transitory machine-readable medium for execution by the processor. Some common forms of machine-readable media include but are not limited to floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a processor or computer is adapted to read. Payment device 702 may also be configured for wired or wireless communication over network 706. Payment device 702 may be a mobile device, such as a mobile phone, a smart phone, or a tablet computer. Payment device 702 may also be a processing device such as a personal computer, a personal digital assistant (PDA), or a notebook computer. Payment device 702 further includes memory 708 or other machine-readable medium which includes instructions for execution by a processor 710 for causing payment device 702 to perform specific functions, such as but not limited to a payment application 712 and other applications 714.

According to some embodiments, payment application 712 can be utilized by a purchaser to create a digital shopping cart, purchase products, process payments, or other financial transactions utilizing the plurality of beacons 704 and network 706. Payment device 702 may also be linked to a payment account stored in an account database on a payment provider server (not shown) for direct or automatic payment or exchange of funds between the purchase and merchant. Payment application 712 includes instructions for execution by a processor 710, such as a software program or application, which provides a graphical user interface (GUI) for interfacing and communicating with the purchaser and the plurality of beacons 704 through radio frequency (RF) transceiver 716. In some embodiments, payment application 710 may allow a purchaser to enter recipient payment information, purchaser account information, or log in information to access the purchaser's account information or other related information that may permit a purchaser to make a payment to a merchant. Payment application 710 also may include a payment gateway to authorize or reject payment transactions through a third party service provider (not shown) utilizing network 706.

Payment device 702 further includes a network interface component 718 configured for communication with network 706. According to some embodiments, network interface component 718 includes a wireless communication component, such as a wireless broadband component, a wireless satellite component, or other types of wireless communication components including radio frequency (RF), microwave frequency (MWF), or infrared (IR) components configured for communication with network 706. Network interface component 718 may also be configured to interface with a digital subscriber line (DSL) modem, a public switched telephone network (PSTN) modem, an Ethernet device, or various other types of wired or wireless network communication devices adapted for communication with network 706.

According to some embodiments, the plurality of beacons 704 may include any appropriate combination of hardware or software having a processor and capable of reading instructions stored in memory or other machine-readable medium for execution by the processor. The beacons 704 include a RF transceiver (not shown) capable of transmitting and/or receiving communications using RF protocol. The beacons 704 typically will include data related to products desired to be purchased such as but not limited to product details and payment information. The beacons 704 will be fixed to multiple areas around a store. The beacons 704 continually send out a signal to listening devices such as but not limited to payment device 702. The payment device 702 can triangulate signals from multiple beacons 704 to determine the location of payment device 702 within the store. The payment application 712 makes use of this triangulation process to display, on the payment device 702, products that a purchaser is standing near, allowing the purchaser to select one or more products desired for purchase. The purchaser then uses the payment application 712 to purchase the desired products. This enables a purchaser to quickly pay for particular products that the purchaser would like to buy, without having to wait at a checkout line. The payment application 712 will process and authorize the transaction, displaying a receipt screen if successful. The purchaser may then leave the store with the purchased product, or continue to shop for other products and repeating the payment process utilizing the payment device 702 for the other products. The purchaser thus saves time by avoiding checkout lines to purchase products.

The plurality of beacons 704 may additionally be used by a merchant to keep track of product information. The merchant may wish to determine which products or how much of a product is being purchased during a specified period. The merchant can use this data to efficiently stock their store with more products purchasers desire and less products purchasers seldom buy.

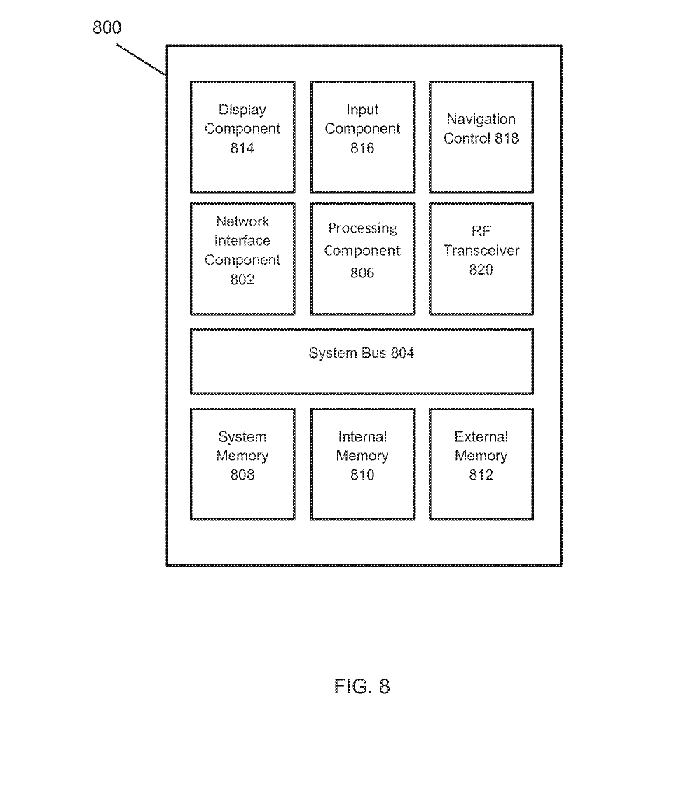

FIG. 8 is a diagram of a payment device 800 held by a purchaser according to an embodiment of the present invention. Payment device 800 may correspond to payment device 702 in FIG. 7. Payment device 800 may be a mobile device, such as a smart phone, mobile phone, netbook, notebook computer, or tablet computer. Device 800 includes a network interface component 802 configured for communication with a network such as network 706 in FIG. 7. According to some embodiments, network interface component 802 includes a wireless communication component, such as a wireless broadband component, a wireless satellite component, or various other types of wireless communication components including radio frequency (RF), microwave frequency (MWF), or infrared (IR) components configured for communication with network 706. In other embodiments, network interface component may be configured to interface with a digital subscriber line (DSL) modem, a public switched telephone network (PSTN) modem, an Ethernet device, or various other types of wired or wireless network communication devices adapted for communication with network 706.

According to some embodiments, payment device 800 includes a system bus 804 for interconnecting various components within payment device 800 and communication information between the various components. Various components may include but are not limited to a processing component 806, a system memory component 808, an internal memory component 810, and a static memory component 812. Processing component 806 may encompass but is not limited to a processor, microcontroller, or a digital signal processor (DSP). System memory component 808 may correspond to random access memory (RAM), internal memory component 810 may correspond to read-only memory (ROM), and static memory 812 may correspond to optical, magnetic, or solid-state memories.

According to some embodiments, payment device 800 includes a display component 814 for displaying information to a purchaser using payment device 800. Display component 814 may be a liquid crystal display (LCD) screen, an organic light emitting diode (OLED) screen, an active matrix OLED (AMOLED), an LED screen, a plasma display, or a cathode ray tube (CRT) display. Payment device 800 further includes an input component 816, which enables a purchaser using payment device 800 to input information into payment device 800. Such information could include but is not limited to payment information, account information, verification information, or identification information. In some embodiments, input component 816 may include a keyboard or key pad. Payment device 800 may also include a navigation control component 818, configured to enable a purchaser using the device 800 to navigate along display component 814. In some embodiments, navigation control component 818 may be a mouse, a trackball, or other such device. In other embodiments, payment device 800 includes a touchscreen such that display component 814, input component 816, and navigation control 818 may be a single integrated component.

According to some embodiments, payment device 800 includes a RF transceiver 820 for transmitting and receiving information over UHF protocol. UHF designates radio frequencies in the range between about 300 MHz and 3 GHz for transmitting and receiving information based on distances ranging from about 1 to 50 meters. RF transceiver 820 may be utilized by payment device 800 to transmit and/or receive information over a short distance to nearby beacons 704 using UHF protocol. Such information may include but is not limited to location information, payment information, identification information, and/or account information.

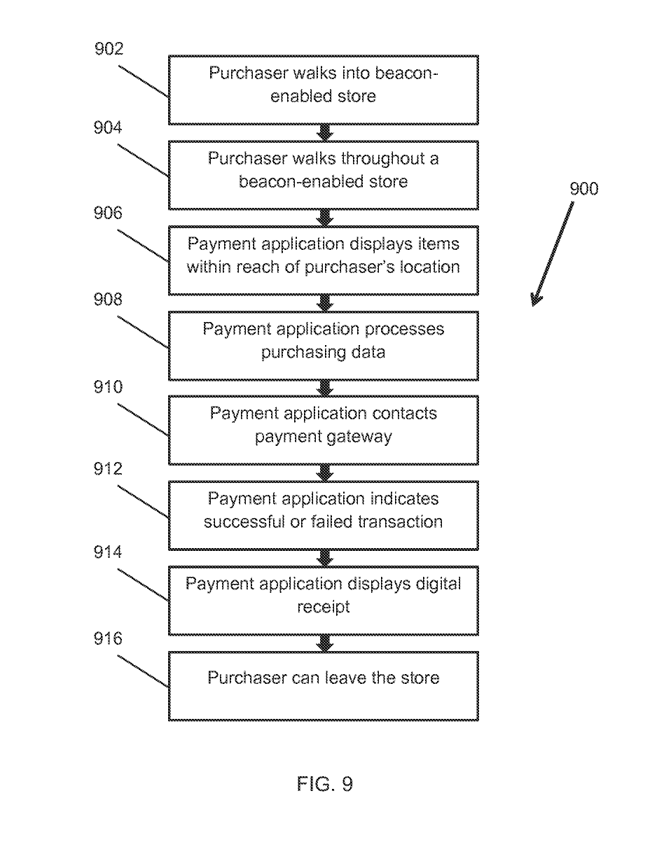

FIG. 9 is a flowchart illustrating a payment method 900 utilizing beacon technology according to an embodiment of the present invention. The method 900 illustrated in FIG. 9 will be described in association with FIG. 7. According to some embodiments, the method 900 shown in FIG. 9 may allow a purchaser with a payment device, such as payment device 702 having RF transceiver 716, payment application 712, and network connectivity through network interface component 718 to purchase products from a merchant without having to wait in line at a checkout counter. It is understood that steps in method 900 may be repeated, rearranged, or removed without limiting the object and scope of the invention.

As the start of the payment method 900 in FIG. 9, a purchaser is entering a beacon technology enable store. At step 902, the purchaser with payment device 702 walks into the beacon-enable store. The payment device 702 picks up a signal from a nearby beacon 704 through RF transceiver 716 indicating that all purchases within this store should be associated with the store the purchaser has entered. Alternatively, the store could be recognized through location data such as but not limited to utilizing a GPS. At step 904, the purchaser walks throughout the beacon-enabled store looking for items to purchase. As the purchaser travels, the payment application 712 triangulates the signals from nearby beacons 704 to locate the purchaser within the store. The payment application 712 may be opened in order to triangulate the signal, or the payment application 712 may triangulate the signal in the background while the payment device 702 is turned on. At step 906, based on the information transmitted from nearby beacons 704 using the location of the purchaser, the payment application 712 displays the items within reach of the purchaser's location. The purchaser may then select the one or more items desired to be purchased on the payment application 712 and also take the desired items from where they are displayed. At step 908, payment application 712 processes the purchasing data corresponding to each item desired to be purchased. The purchasing data and merchant information are sent to and saved on a payment server through network 706. More than one item desired to be purchased may be processed before the purchaser utilizes the payment application 712 to purchase their items. For instance, a purchaser may repeat steps 902 through 908 until the purchaser has determined he or she has all the items desired to be purchased. The payment application 712 may collect this data and provide the purchaser with a list of items, corresponding prices, and a total price of all items displayed on the payment device 702. The purchaser may then have the ability to remove items from the list displayed on the payment device 702 should they ultimately decide not to purchase an item.

At step 910, the purchaser has completed shopping, so the payment application 712 contacts the payment gateway to authorize the payment transaction. The payment transaction is authorized through a third party payment processor based on previously input purchaser information, such as but not limited to credit or debit card information. The payment transaction also incorporates any discounts or price reductions, through the use of coupons, rewards cards, rebates, or other price reduction means. Additional security features may be implemented as well, such as purchaser authentication, in order to prevent fraudulent payment transactions. The authentication request may result in a notification on the payment device 702 asking for authorization. The request for authorization may also be a short messaging service (SMS) message or an e-mail requesting a reply to authorize the transaction. The purchaser then replies to the notification, message, or email in order to continue the payment process. At step 712, based on receipt and processing from the third party payment gateway, a success or failure message is displayed on the payment device 702 in order to inform the purchaser that their payment was successful or not. At step 714, if the payment was processed successfully, a receipt is displayed on the patent device 702; otherwise, an error message is displayed to alert the purchaser that their payment was not successful. If successful, at step 916, the purchaser is free to leave the store with their purchased item, optionally displaying the receipt to a store clerk prior to leaving. After a successful purchase, the payment device may optionally send a request to deactivate pre-existing antitheft mechanisms (such as but not limited to RFID tags) that merchants may have placed on higher value items. The purchaser may alternatively continue to shop by repeating the previous steps throughout this method. If the purchaser has forgotten to complete their purchase, the beacons 704 can prompt the purchaser to complete shopping if the purchaser attempts to leave the range of the beacons 704 without paying.

In an alternative embodiment, payment authorization at step 910 is commenced at a later time from payment processing such that a purchaser may purchase items from multiple stores, the payment application ultimately compiling and authenticating all the purchases at a later time when the purchaser has completed shopping entirely.

It is understood that the above-described embodiments are only illustrative of the application of the principles of the present invention and may be combined into a single embodiment without departing from the spirit and object of the present invention. Further, the present invention may be embodied in other specific forms without departing from its spirit or essential characteristics. The described embodiment is to be considered in all respects only as illustrative and not restrictive. The scope of the invention is, therefore, indicated by the appended claims rather than by the foregoing description. All changes which come within the meaning and range of equivalency of the claims are to be embraced within their scope. Thus, while the present invention has been fully described above with particularity and detail in connection with what is presently deemed to be the most practical and preferred embodiment of the invention, it will be apparent to those of ordinary skill in the art that numerous modifications, including, but not limited to, variations in size, materials, shape, form, function and manner of operation, assembly and use may be made, without departing from the principles and concepts of the invention as set forth in the claims. Further, it is contemplated that an embodiment may be limited to consist of or to consist essentially of one or more of the features, functions, structures, methods described herein.

What is claimed is:

1. A method for purchasing items from a payment device utilizing near field communication (NFC) technology comprising:
approaching an item desired to be purchased and opening a payment application on the payment device, the payment application configured for interfacing and communicating with a purchaser and a plurality of NFC tags;
bringing the payment device into proximity with a NFC tag of a plurality of NFC tags, the NFC tag placed on or near the item desired to be purchased;
transmitting purchasing data to the payment device over NFC protocol;
processing through the payment application the purchasing data, the processing including contacting a payment gateway to authorize a financial transaction for purchasing the item; and
indicating on the payment application a successful or failed financial transaction.

2. The method of claim 1, wherein communication between the payment device and plurality of NFC tags is transmitted through NFC transceivers.

3. The method of claim 1, wherein the purchasing data comprises item details and payment information corresponding to the item desired to be purchased.

4. The method of claim 1, wherein the payment application displays a digital receipt for successful financial transactions.

5. The method of claim 1, wherein more than one item desired to be purchased is transmitted to the payment device and processed prior to contacting the payment gateway to authorize the financial transaction.

6. The method of claim 1, further comprising removing an item no longer desired to be purchased by bringing the payment device into proximity with the NFC tag to transmit to the NFC tag that the item is no longer being purchased.

7. The method of claim 1, further comprising removing an item no longer desired to be purchased by removing the item on the payment application.

8. The method of claim 1, wherein the financial transaction is authorized based on previously input purchaser information.

9. The method of claim 1, wherein processing the purchasing data further comprises incorporating price reductions.

10. The method of claim 1, further comprising sending a request for authorization to the payment device to prevent fraudulent payment transactions.

11. The method of claim 10, further comprising responding to the request for authorization in order to continue the payment process.

12. The method of claim 1, wherein the financial transaction is authorized after the purchaser has left a store.

13. The method of claim 1, further comprising displaying an error message for failed financial transactions.

14. The method of claim 1, further comprising sending a request from the payment device to deactivate an antitheft mechanism placed on the item desired to be purchased.

15. The method of claim 1, further comprising repeating the method as the purchaser continues to shop.

16. The method of claim 1, wherein the payment device comprises a mobile device.

17. A payment system utilizing near field communication (NFC) technology comprising:
a payment device configured to process a financial transaction for an item desired to be purchased, the payment device comprising:
a processor capable of reading instructions stored on a non-transitory machine-readable medium for execution by the processor;
a payment application including payment instructions for receiving purchasing data over NFC protocol and authorizing the financial transaction; and
a NFC transceiver capable of transmitting and/or receiving the purchasing data using NFC protocol;
a plurality of NFC tags, wherein each individual NFC tag is placed on or near a corresponding item desired to be purchased, each individual NFC tag of the plurality of NFC tags comprising:
a processor capable of reading instructions stored on a non-transitory machine-readable medium for execution by a processor, and
a NFC transceiver capable of transmitting and/or receiving the purchasing data using NFC protocol; and
a network capable of sending and receiving purchasing data to and from a payment gateway in order to authorize the financial transaction.

18. The payment system of claim 17, wherein the purchasing data comprises item details and payment information corresponding to the item desired to be purchased.

19. The payment system of claim 17, wherein the payment device comprises a mobile device.

20. The payment system of claim 17, wherein the payment device is linked to a payment account stored in an account database on a payment provider server for direct or automatic payments.

21. The payment system of claim 17, wherein the payment application comprises a graphical user interface for interfacing and communicating with the purchaser.

22. The payment system of claim 17, wherein the payment application allows a purchaser to enter payment information, purchaser account information, or log in information.

23. The payment system of claim 17, wherein the payment device further comprises a network interface component for communication with the network.

24. The payment system of claim 17, wherein the plurality of NFC tags further comprises a network interface component for communication with the network.

25. The payment system of claim 17, wherein the network comprises a wireless telecommunications networks adapted for communication with one or more other communication networks, such as the internet

26. A non-transitory computer-readable medium having instructions for execution by a processor, the instructions causing the processor, when executed, to perform a method comprising:
initiating a financial transaction for an item desired to be purchased;
receiving purchasing data from a near field communication (NFC) tag placed on or near the item desired to be purchased, the purchasing data provided using NFC protocol;
authorizing the financial transaction for purchasing the item by contacting a payment gateway; and
indicating a successful or failed financial transaction by displaying a digital receipt if successful.

27. The method of claim 26, wherein the purchasing data comprises item details and payment information corresponding to the item desired to be purchased.

28. The method of claim 26, wherein the payment device comprises a mobile device.

29. The method of claim 26, wherein the financial transaction is authorized based on previously input purchaser information.

30. A method for purchasing items from a payment device utilizing barcode technology comprising:
approaching an item desired to be purchased and opening a payment application on the payment device, the payment application configured for interfacing and communicating with a purchaser;
scanning a barcode corresponding to the item desired to be purchased on the payment device, the barcode placed on or near the item desired to be purchased;
decoding the scanned barcode in order to extract purchasing data stored therein;
processing through the payment application the purchasing data, the processing including contacting a payment gateway to authorize a financial transaction for purchasing the item; and
indicating on the payment application a successful or failed financial transaction.

31. The method of claim 30, wherein scanning a barcode comprises scanning with a scanning capable device, the scanning capable device including but not limited to a camera or barcode scanner.

32. The method of claim 30, wherein decoding the scanned barcode comprises decoding with a barcode reader program on the payment device.

33. The method of claim 30, wherein the purchasing data comprises item details and payment information corresponding to the item desired to be purchased.

34. The method of claim 30, wherein the payment application displays a digital receipt if the financial transaction was successful.

35. The method of claim 30, wherein more than one item desired to be purchased is transmitted to the payment device and processed prior to contacting the payment gateway to authorize the financial transaction.

36. The method of claim 30, further comprising scanning a store-identifying barcode.

37. The method of claim 30, further comprising utilizing location data to identify a store the purchaser has entered.

38. The method of claim 30, further comprising removing an item no longer desired to be purchased by rescanning the barcode on the item no longer being purchased.

39. The method of claim 30, further comprising removing an item no longer desired to be purchased by removing the item on the payment application.

40. The method of claim 30, wherein the financial transaction is authorized based on previously input purchaser information.

41. The method of claim 30, wherein processing the purchasing data further comprises incorporating price reductions.

42. The method of claim 30, further comprising sending a request for authorization to the payment device.

43. The method of claim 42, further comprising responding to the request for authorization.

44. The method of claim 30, wherein the financial transaction is authorized after the purchaser has left a store.

45. The method of claim 30, further comprising displaying an error message for failed financial transactions.

46. The method of claim 30, further comprising sending a request from the payment device to deactivate an antitheft mechanism placed on the item desired to be purchased.

47. The method of claim 30, further comprising repeating the method as the purchaser continues to shop.

48. The method of claim 30, wherein the payment device comprises a mobile device.

49. A payment system utilizing barcode technology comprising:
a payment device configured to process a financial transaction for an item desired to be purchased, the payment device comprising:
a processor capable of reading instructions stored on a non-transitory machine-readable medium for execution by the processor;
a payment application including payment instructions for receiving purchasing data extracted from scanned barcodes and authorizing the financial transaction;
a scanning capable device for scanning a barcode corresponding to the item desired to be purchased; and
a barcode reader program capable of decoding the scanned barcode in order to extract purchasing data stored therein;
a plurality of barcodes, wherein each individual barcode is placed on or near a corresponding item desired to be purchased; and
a network capable of sending and receiving purchasing data to and from a payment gateway in order to authorize the financial transaction.

50. The payment system of claim 49, wherein the purchasing data comprises item details and payment information corresponding to the item desired to be purchased.

51. The payment system of claim 49, wherein the scanning capable device comprises a camera or barcode scanner.

52. The payment system of claim 49, wherein the payment device comprises a mobile device.

53. The payment system of claim 49, wherein the payment device is linked to a payment account stored in an account database on a payment provider server for direct or automatic payments.

54. The payment system of claim 49, wherein the payment application comprises a graphical user interface for interfacing and communicating with the purchaser.

55. The payment system of claim 49, wherein the payment application allows a purchaser to enter payment information, purchaser account information, or log in information.

56. The payment system of claim 49, wherein the payment device further comprises a network interface component for communication with the network.

57. The payment system of claim 49, wherein the plurality of barcodes are one dimensional barcodes, two dimensional barcodes, or three dimensional barcodes.

58. The payment system of claim 49, wherein the network comprises a wireless telecommunications networks adapted for communication with one or more other communication networks, such as the internet

59. A non-transitory computer-readable medium having instructions for execution by a processor, the instructions causing the processor, when executed, to perform a method comprising:
initiating a financial transaction for an item desired to be purchased;
receiving coded data from scanning a barcode placed on or near the item desired to be purchased;
extracting purchasing data from the coded data;
authorizing the financial transaction for purchasing the item by contacting a payment gateway; and
indicating a successful or failed financial transaction by displaying a digital receipt if successful.

60. The method of claim 59, wherein the purchasing data comprises item details and payment information corresponding to the item desired to be purchased.

61. The method of claim 59, wherein the payment device comprises a mobile device.

62. The method of claim 59, wherein the financial transaction is authorized based on previously input purchaser information.

63. A method for purchasing items from a payment device utilizing beacon technology comprising:
opening a payment application on the payment device, the payment application configured for interfacing and communicating with a purchaser and a plurality of beacons over radio frequency (RF) protocol;
walking around a beacon-enabled store such that signals from beacons nearby a purchaser triangulate to locate the purchaser and display items for purchase within reach of the purchaser's location;
selecting one or more items desired to be purchased on the payment application;
processing through the payment application the one or more items desired to be purchased, the processing including contacting a payment gateway to authorize a financial transaction for purchasing the item; and
indicating on the payment application a successful or failed financial transaction.

64. The method of claim 63, wherein communication between the payment device and plurality of beacons is transmitted through RF transceivers.

65. The method of claim 63, wherein the display of items for purchase comprises item details and payment information.

66. The method of claim 63, wherein the payment application displays a digital receipt for successful financial transactions.

67. The method of claim 63, further comprising entering a beacon-enable store such that a nearby beacon indicates to the payment device that all purchases within the store should be associated with that store.

68. The method of claim 63, further comprising removing an item no longer desired to be purchased by removing the item on the payment application.

69. The method of claim 63, wherein the financial transaction is authorized based on previously input purchaser information.

70. The method of claim 63, wherein processing the purchasing data further comprises incorporating price reductions.

71. The method of claim 63, further comprising sending a request for authorization to the payment device to prevent fraudulent payment transactions.

72. The method of claim 71, further comprising responding to the request for authorization in order to continue the payment process.

73. The method of claim 63, wherein the financial transaction is authorized after the purchaser has left a store.

74. The method of claim 63, further comprising displaying an error message for failed financial transactions.

75. The method of claim 63, further comprising sending a request from the payment device to deactivate an antitheft mechanism placed on the item desired to be purchased.

76. The method of claim 63, further comprising repeating the method as the purchaser continues to shop.

77. The method of claim 63, wherein the payment device comprises a mobile device.

78. A payment system utilizing beacon technology comprising:
a payment device configured to process a financial transaction for an item desired to be purchased, the payment device comprising:
a processor capable of reading instructions stored on a non-transitory machine-readable medium for execution by the processor;
a payment application including payment instructions for receiving location based purchasing data over radio frequency (RF) protocol and authorizing the financial transaction; and
a RF transceiver capable of transmitting and/or receiving location based purchasing data using RF protocol;
a plurality of beacons, wherein each individual beacon is placed throughout a store to triangulate location data corresponding to items desired to be purchased, each individual beacon of the plurality of beacons comprising:
a processor capable of reading instructions stored on a non-transitory machine-readable medium for execution by a processor, and
a RF transceiver capable of transmitting and/or receiving location based purchasing data using RF protocol; and
a network capable of sending and receiving purchasing data to and from a payment gateway in order to authorize the financial transaction.

79. The payment system of claim 78, wherein the location based purchasing data comprises location information of the purchaser within the store, and/or item details and payment information corresponding to the item desired to be purchased.

80. The payment system of claim 78, wherein the payment device comprises a mobile device.

81. The payment system of claim 78, wherein the payment device is linked to a payment account stored in an account database on a payment provider server for direct or automatic payments.

82. The payment system of claim 78, wherein the payment application comprises a graphical user interface for interfacing and communicating with the purchaser.

83. The payment system of claim 78, wherein the payment application allows a purchaser to enter payment information, purchaser account information, or log in information.

84. The payment system of claim 78, wherein the payment device further comprises a network interface component for communication with the network.

85. The payment system of claim 78, wherein the network comprises a wireless telecommunications networks adapted for communication with one or more other communication networks, such as the internet

86. A non-transitory computer-readable medium having instructions for execution by a processor, the instructions causing the processor, when executed, to perform a method comprising:
initiating a financial transaction for an item desired to be purchased;
receiving location based purchasing data from a plurality of beacons placed throughout a store;
authorizing the financial transaction for purchasing the item by contacting a payment gateway; and
indicating a successful or failed financial transaction by displaying a digital receipt if successful.

87. The method of claim 86, wherein the location based purchasing data comprises location information of a purchase within the store, and/or item details and payment information corresponding to the item desired to be purchased.

88. The method of claim 86, wherein the payment device comprises a mobile device.

89. The method of claim 86, wherein the financial transaction is authorized based on previously input purchaser information.
